(19) United States
(12) Patent Application Publication
(10) Pub. No.: US 2013/0322102 A1
(43) Pub. Date: Dec. 5, 2013

(54) INDICATOR LIGHT

(71) Applicant: Maryline Thorailler, Ormesson Sur Marne (FR)

(72) Inventor: Maryline Thorailler, Ormesson Sur Marne (FR)

(73) Assignee: VALEO SYSTEMES THERMIQUES, Le Mesnil Saint Denis (FR)

(21) Appl. No.: 13/993,398

(22) PCT Filed: Dec. 14, 2011
(86) PCT No.: PCT/FR11/00646

§ 371 Date: Aug. 22, 2013

(30) Foreign Application Priority Data
Dec. 14, 2010 (FR) 1004879

(51) Int. Cl. F21S 8/10; F21V 8/00

(52) U.S. Cl. CPC F21S 48/236; G02B 6/0001
USPC 362/487; 362/296.05

(57) ABSTRACT

The invention relates to an indicator light comprising: a light source; a rigid optical guide forming a column, comprising: an inlet optical surface delimiting the lower surface of the optical guide and through which the light of the light source enters into the optical guide; an outlet optical surface delimiting the upper surface of the optical guide and through which the light of the light source is emitted; a rectangular section over at least a major portion of length thereof, characterized in that, for at least one angular opening (a) centered at a preferred outlet direction, the light source is arranged on the side of the inlet optical surface, at the intersection between a longitudinal axis (A) of the optical guide, and the path of a reverse virtual ray corresponding to the path of a light ray emitted by the source in the reverse direction, the reverse virtual ray entering into the optical guide through the outlet optical surface by impinging in the preferred direction, being refracted by the outlet optical surface, and being reflected at least once by the side walls of the optical guide, and in that the inlet optical surface (9) of the optical guide comprises a planar surface portion which is arranged on the path of said virtual ray and perpendicular to said ray at the inlet optical surface.

The invention relates to a warning or indicator light, in particular for a vehicle dashboard, which alerts a user by means of a luminous signal.

It is known to produce warning lights by means of a light guide that guides light emitted by a light source, generally a light-emitting diode (LED), toward a surface to be illuminated.

The light guide generally takes the form of an elongate transparent plastic part that is generally a parallelepiped or tubular. It possesses an input surface or dioptre directed toward the light source and an output surface or dioptre corresponding to the surface to be illuminated of the indicator. The surface to be illuminated may furthermore comprise masks or marks forming pictograms that will be clearly apparent under illumination, intended to indicate the function or alarm to which the indicator light relates.

Light guides having flat input dioptres generate a bright illumination around the axis of the guide, but an observer located to the side of the warning light receives only a small proportion of the emitted luminosity. In order to meet manufacturer requirements, a warning light comprising such a light guide requires a powerful light source. However, powerful light sources are more expensive, require more power and generate more heat, which must be evacuated.

It is known to produce hemispherical or at least concave rounded input dioptres in order to equally distribute the power radiated by the warning light over all possible angles of observation.

The luminosity is then better distributed to the sides, but the power transmitted in the particular direction of an observer is lower for a given illumination power.

In particular, in the case of a vehicle dashboard, the position of the observers, driver and passenger, is known and fixed relative to the warning light. Thus, most of the radiated power is wasted since the warning light also emits in unnecessary directions, especially toward the ground and ceiling of the vehicle, where no user is present. To improve the appearance of the warning light it is therefore again necessary to use relatively high-power light-emitting diodes.

In addition, because of the shape of the diodes, indicator lights equipped with such light guides having input dioptres with flat or rounded surfaces exhibit a less illuminated dark zone in the center of the illuminated surface when observed straight-on, which degrades the appearance of the warning light.

A vehicle dashboard generally comprises a plurality of such warning lights, generally about ten. The use of high-power diodes therefore involves a non-negligible additional cost. In addition, their high power consumption is a burden on the electrical power supply, and devices for dissipating the heat produced must be provided.

In order to at least partially overcome the aforementioned drawbacks, one subject of the invention is a warning light comprising:
a light source; and
a rigid light guide forming a column, comprising:
   an input dioptre bounding the lower surface of the light guide and via which light from the source enters the light guide,
   an output dioptre bounding the upper surface of the light guide and via which light from the source is emitted, and
   a rectangular section over at least most of its length,

characterized in that, for at least one angular aperture centered on a privileged output direction, the source is placed beside the input dioptre at the intersection between a longitudinal axis of the light guide and the path of a reverse virtual ray corresponding to the path of a light ray emitted by the source traveled in reverse, the reverse virtual ray being incident on the light guide in the privileged direction and entering therein via the output dioptre, refracted by the output dioptre and reflected at least once by the sidewalls of the light guide, and in that the input dioptre of the light guide comprises a flat surface portion, placed on the path of said virtual ray and perpendicular to the latter at the input dioptre.

The warning light thus obtained concentrates the radiated power in a direction in which it will be seen by the user, whereas angles that do not correspond to the expected positions of users will be less well illuminated, or even not at all.

For a given appearance from the point of view of the user, it will thus be possible to use a less powerful light-emitting diode, and therefore one that is less expensive, consumes less power and produces less heat to be evacuated. In addition, the dark zone in the center of the illuminated surface is observed to disappear.

The warning light may furthermore have one or more of the following features, whether applied individually or in combination.

The light source is a light-emitting diode.

The light guide is made of a hard plastic.

The hard plastic is polymethyl methacrylate.

The hard plastic is polycarbonate.

The sidewalls and the input dioptre are polished having a surface roughness smaller than 0.05 microns.

The light guide has an end portion of circular cross section beside the output dioptre, the end portion of circular cross section being connected to the portion of rectangular cross section via a gradual transition in the shape of the cross section.

The input dioptre of the light guide comprises a plurality of flat surface portions, each lying perpendicular to a reverse virtual ray incident in a direction privileged over a number of privileged directions.

The input dioptre of the light guide comprises a plurality of flat surface portions lying parallel to one other and to the flat surface portion oriented perpendicularly to a reverse virtual ray at the input dioptre, contained in a preset thickness and separated by surfaces lying perpendicular to the output dioptre.

The input dioptre of the light guide comprises a plurality of flat surface portions lying parallel to one another and to the flat surface portion oriented perpendicularly to a reverse virtual ray at the input dioptre, separated by surfaces lying parallel to the output dioptre.

The length of the light guide between the output dioptre and the input dioptre is such that the reverse virtual ray is reflected once by a sidewall.

Another subject of the invention is a dashboard for an automotive vehicle, characterized in that it comprises at least one warning light such as described above, and in that the privileged direction corresponds to the expected position of a user of the vehicle.

In particular, the dashboard may comprise at least one warning light for which the privileged directions are two in number, and correspond to the expected positions of the driver of the vehicle and of the passenger of the vehicle in the passenger compartment.

Other advantages and features will become apparent on reading the description of the following figures, in which:

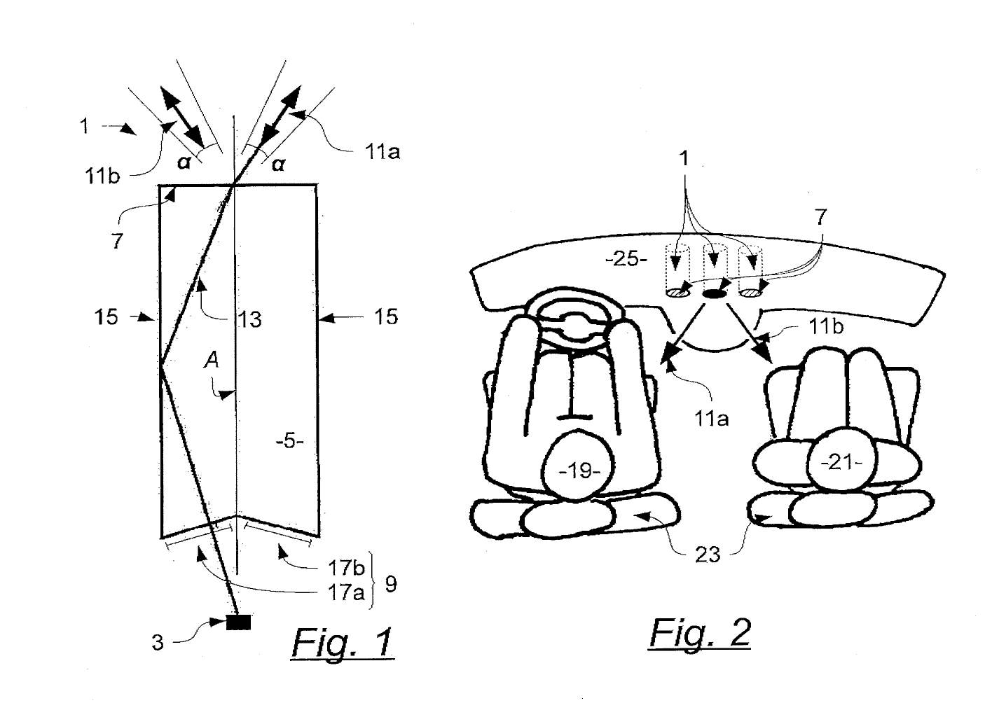

FIG. 1 is a schematic cross-sectional view of a warning light light guide according to the invention;

FIG. 2 is a schematic view from above of the interior of the passenger compartment of a vehicle comprising a warning light according to the invention;

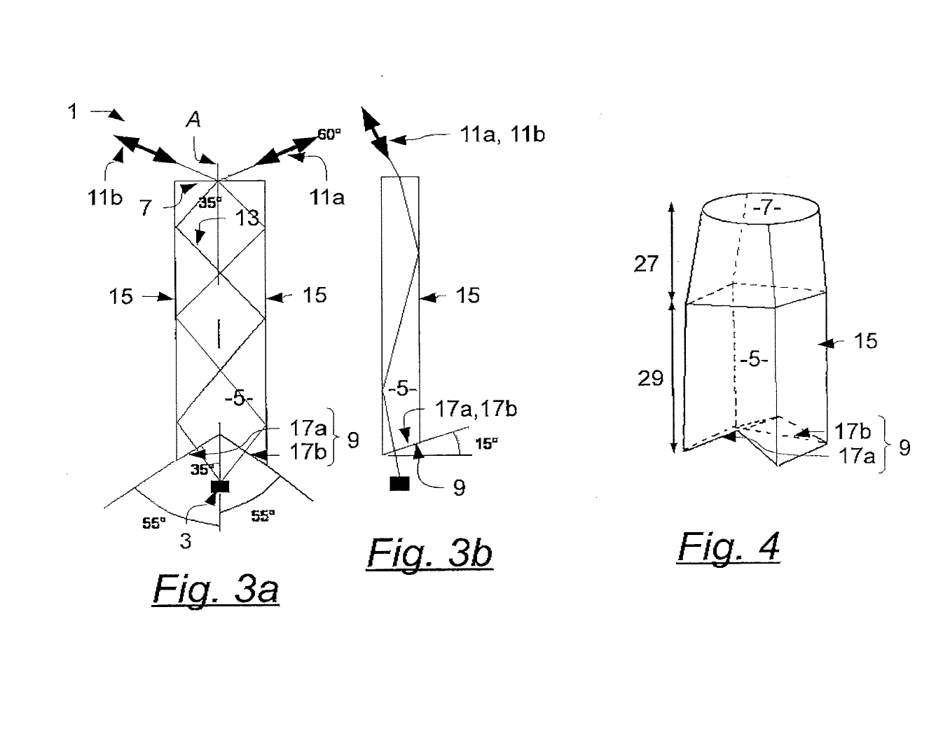

FIG. 3a is a schematic front view of a variant of the warning light according to the invention;

FIG. 3b is a schematic side view of the variant in FIG. 3a;

FIG. 4 is a perspective view of another variant light guide;

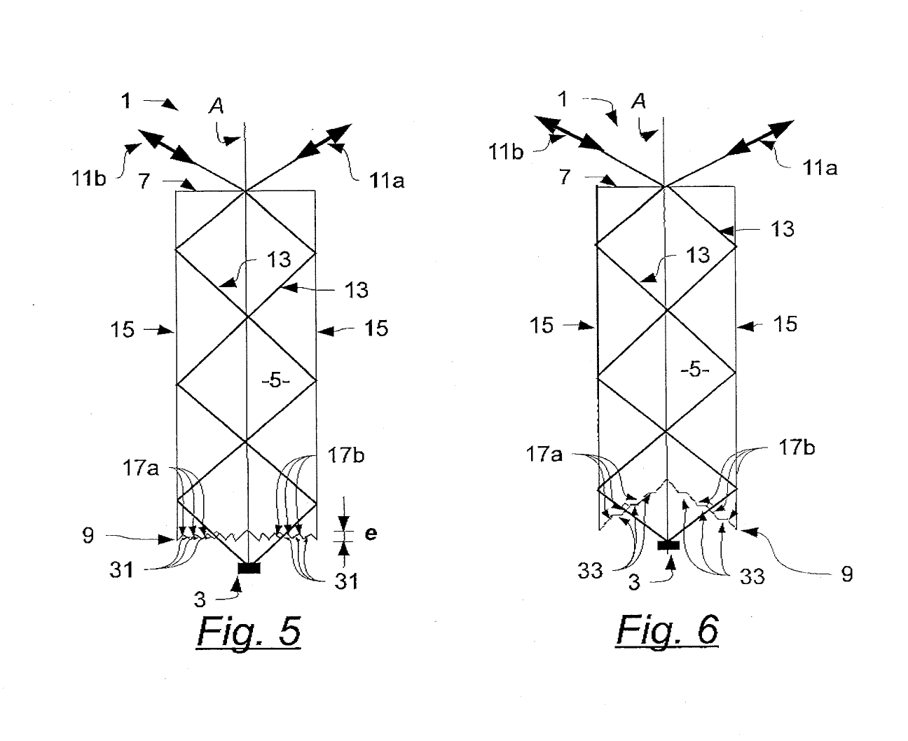

FIG. 5 is a schematic cross-sectional view of an alternative embodiment of a warning light light guide according to the invention; and

FIG. 6 is a schematic cross-sectional view of a second alternative embodiment of a warning light light guide according to the invention.

In all the figures the same references relate to the same elements.

The invention relates to a warning light, in particular for a vehicle dashboard. The warning light 1 comprises a source 3 and a light guide 5.

In FIG. 1, it may be seen that the light guide 5 has a generally elongate shape forming a column having a longitudinal axis A. Its upper surface, positioned on the user side, is for example flat and forms an output dioptre 7 via which light from the source 3 is emitted. Alternatively, the output dioptre may be a curved and especially slightly rounded surface. The lower surface of the light guide 5, positioned on the same side as the light source 3, forms an input dioptre 9 via which light from the source 3 enters into the light guide 5. The light guide 5 has a rectangular and optionally square cross section over most of its length, and even over all of its length as in the present case. This length portion of rectangular cross section has as its central axis the longitudinal axis A.

The light source 3 is, for example, a light-emitting diode (LED). The light guide is preferably made of a hard plastic, for example polymethyl methacrylate (PMMA or Plexiglas™), or even of polycarbonate.

For an angular aperture a centered on a privileged output direction 11a, a reverse virtual ray 13 may be defined corresponding to the path of a light ray emitted by the source 3 traveled in reverse.

The reverse virtual ray 13 is incident on the light guide 5 in the privileged direction 11a and enters therein via the output dioptre 7. It is refracted by the output dioptre 7 and reflected at least once by the sidewalls 15 of the light guide 5.

One half, 17a, of the surface of the input dioptre 9, placed on the path of said virtual ray 13, is arranged flat and perpendicular to said ray at the input dioptre 9.

The light source 3 is placed beside the input dioptre 9 at the intersection between the longitudinal axis A of the light guide and the path of the reverse virtual ray 13.

Thus, light emitted by the source 3 in the direction of the flat surface portion 17a retraces the path of the virtual ray 13 and is emitted at the output dioptre 7 as a beam having an angular aperture a centered on the privileged direction 11a.

This beam corresponds to the projection of the image of the flat surface portion 17a along the path of the virtual ray 13, the angular aperture α varying as a function of the size of the flat surface portion 17a and of the distance between the latter and the light source 3. Placing said flat surface 17a closer to the source 3 increases the aperture α. In contrast, increasing the distance between the flat surface 17a and the source 3 decreases the aperture α.

In order to minimize power loss due to reflections from the walls 15, the length of the light guide 5, from the input dioptre 7 to the output dioptre 9, may be chosen so that the virtual ray 13 is reflected just once on its path.

To optimize the reflections and refractions, the sidewalls 15 and the input dioptre 9 of the light guide must be polished and have a surface roughness of about 0.05 micrometers, an order of magnitude smaller than the wavelength used. The output dioptre 7 is roughened in order to obtain a large granularity thereby promoting light scattering and improving the appearance of the warning light.

In the present case, the other half of the input dioptre 9 forms a second flat surface 17b that is obtained by axially symmetric rotation of the first surface 17a about the axis A. This second flat surface 17b enables emission, according to a completely analogous principle, in a second direction 11b that is symmetrical to the first direction 11a. Most of the radiation from the light source 3 is then shared equally between these two privileged directions 11a, 11b.

A warning light 1 may also have more than two surface portions 17a, 17b each one lying perpendicular to a reverse virtual ray 13 incident in a direction 11a, 11b among a number of directions leading for example to the expected positions of at least one user. It is also possible to reduce the relative portion of the input dioptre 9 that at least one of the surfaces 17a, 17b occupies in order to decrease the brightness of the illumination in the corresponding direction 11a or 11b.

FIG. 2 schematically shows the interior of a passenger compartment of a vehicle, seen from above. The users 19, 21 of the vehicle are sat in their seats and face the dashboard 25. The dashboard 25 comprises a number of warning lights 1.

The light guide 5 of the warning lights 1, only the output dioptre 7 of which can be seen, comprises two flat surface portions 17, oriented in order to privilege the directions 11a, 11b leading to the faces of the driver 19 and the passenger 21.

It is also envisaged to privilege only one of the directions 11a or 11b in order for the warning light 1 to be particularly visible to only one of the users 19 or 21 of the vehicle.

FIGS. 3a and 3b show a particular embodiment of the light guide 5, able to be incorporated into a dashboard 25 such as described above.

In FIG. 3a, the input dioptre 9 of the light guide 5 has a V-shape, which opens in the direction of the light source 3, composed of two half-surfaces 17a, 17b. The latter make, in the plane of the figure, an angle of 55° with the longitudinal axis A. The length of the light guide 5 is such that the ray emitted by the source perpendicular to one of the half-surfaces 17a, 17b is reflected three times from the sidewalls 15 of the light guide 5 and exits at the output dioptre 7 in the center of the latter.

The output direction 11a or 11b of said ray 13 is set by the angle between the half-surface 17a or 17b and the axis A and makes, in the present case, with a light guide 5 made of polycarbonate, an angle of about 60°. This angle allows the privileged direction 11a or 11b to be oriented in a horizontal plane.

FIG. 3b shows that the half-surfaces 17a and 17b make, in the plane of the figure, an angle of 15° with the perpendicular to the longitudinal axis A. This angle allows the privileged direction 11a or 11b to be oriented in a vertical plane. In particular, the value range used for this angle allows the beam to be raised to face height from the height of a usual dashboard 25.

FIG. 4 shows a variant of the light guide 5 comprising an end portion 27 of circular cross section beside the output dioptre 7. The end portion 27 of circular cross section is connected to the portion 29 of rectangular cross section via a gradual transition in the shape of the cross section.

Thus, the user sees an illuminated circular surface. Analogously, other geometrical shapes may be obtained.

FIG. 5 shows an alternative embodiment of the warning light 1 comprising a light guide 5 inspired by a Fresnel lens.

The input dioptre 9 of the light guide 5 comprises, for each of the privileged directions 11a, 11b, a plurality of flat surface portions 17a, 17b lying parallel to one another and to a flat surface portion oriented perpendicularly to the reverse virtual ray 13 corresponding to the direction 11a or 11b in question. The surface portions 17a, 17b of each plurality are all contained in a preset thickness e and separated by surface portions 31 lying parallel to the light ray coming from the source incident here on the dioptre.

Such light guides 5 allow the compactness of the warning light 1 along the longitudinal axis A to be increased.

FIG. 6 shows a second embodiment of the light guide 5 of a warning light 1.

In this embodiment, the input dioptre 9 of the light guide 5 comprises, for each of the privileged directions 11a, 11b, a plurality of flat surface portions 17a, 17b lying parallel to one another and to a flat surface portion oriented perpendicularly to the reverse virtual ray 13 corresponding to the direction 11a or 11b in question. The surface portions 17a, 17b of each plurality are separated pairwise by surface portions 33 lying perpendicular to the longitudinal axis A.

Said surface portions 33 lying perpendicular to the longitudinal axis A capture light transmitted in an angular aperture centered on the longitudinal axis A, so as to increase the luminosity of the warning light 1 for an observer facing said light and to make the appearance of the warning light 1 more uniform when the observer changes their viewing angle slightly.

The warning light 1 described above allows certain privileged directions 11a, 11b to be illuminated to the detriment of others. Therefore, the warning light is particularly visible only from certain places (driver 19 or passenger 21) in the passenger compartment of a vehicle, and a certain saving in illumination power may be made. Lower power diodes, and therefore diodes that cost less, may thus be used as light sources 3. Said diodes also produce less heat and the means used to mount the warning light 1 on the dashboard 25 requires less optimization in terms of evacuation of this heat.

1. A warning light comprising:
a light source; and
a rigid light guide forming a column, comprising:
an input dioptre bounding the lower surface of the light guide and via which light from the source enters the light guide,
an output dioptre bounding the upper surface of the light guide and via which light from the source is emitted, and
a rectangular section over at least most of its length,
wherein, for at least one angular aperture (α) centered on a privileged output direction, the source is placed beside the input dioptre at the intersection between a longitudinal axis of the light guide and the path of a reverse virtual ray corresponding to the path of a light ray emitted by the source traveled in reverse, the reverse virtual ray being incident on the light guide in the privileged output direction and entering therein via the output dioptre, refracted by the output dioptre and reflected at least once by sidewalls of the light guide, and
wherein the input dioptre of the light guide comprises a flat surface portion, placed on the path of said virtual ray and perpendicular to the latter at the input dioptre.

2. The warning light as claimed in claim 1, wherein the light source is a light-emitting diode.

3. The warning light as claimed in claim 1, wherein the light guide is made of a hard plastic.

4. The warning light as claimed in claim 3, wherein the hard plastic is polymethyl methacrylate.

5. The warning light as claimed in claim 3, wherein the hard plastic is polycarbonate.

6. The warning light as claimed in claim 1, wherein the sidewalls and the input dioptre are polished having a surface roughness smaller than 0.05 microns.

7. The warning light as claimed in claim 1, wherein the light guide has an end portion of circular cross section beside the output dioptre, the end portion of circular cross section being connected to the portion of rectangular cross section via a gradual transition in the shape of the cross section.

8. The warning light as claimed in claim 1, wherein the input dioptre of the light guide comprises a plurality of flat surface portions, each lying perpendicular to a respective reverse virtual ray incident in a direction privileged over a number of other directions.

9. The warning light as claimed in claim 1, wherein the input dioptre of the light guide comprises a plurality of flat surface portions lying parallel to one other, one of the flat surface portions being oriented perpendicularly to a reverse virtual ray at the input dioptre, contained in a preset thickness and separated by surface portions lying parallel to the ray coming from the source incident here on the dioptre.

10. The warning light as claimed in claim 1, wherein the input dioptre of the light guide comprises a plurality of flat surface portions lying parallel to one another, one of the flat surface portions being oriented perpendicularly to a reverse virtual ray at the input dioptre, separated by surface portions lying perpendicular to the optical axis A.

11. The warning light as claimed in claim 1, wherein the length of the light guide between the output dioptre and the input dioptre is such that the reverse virtual ray is reflected just once by a sidewall on its path.

12. A dashboard for an automotive vehicle, comprising at least one warning light as claimed in claim 1, wherein the privileged direction corresponds to the expected position of a user of the vehicle.

13. The dashboard as claimed in claim 12, further comprising at least one warning light according to at least claim 8, wherein the privileged directions are two in number, and correspond to the expected positions of the driver and the passenger of the vehicle in the passenger compartment.
